(19) United States
(12) Patent Application Publication
(10) Pub. No.: US 2019/0001638 A1
(43) Pub. Date: Jan. 3, 2019

(54) MULTILAYER BREATHABLE FILMS AND LAMINATES INCLUDING THE SAME

(71) Applicant: Berry Global, Inc., Evansville, IN (US)

(72) Inventors: Rongguo Zhao, Mooresville, NC (US); Linda Fu, Suzhou (CN); Vadim Zaikov, Chippewa Falls, WI (US); Gregory Wagner Farell, Hendersonville, TN (US)

(21) Appl. No.: 16/018,637

(22) Filed: Jun. 26, 2018

Related U.S. Application Data
(60) Provisional application No. 62/525,883, filed on Jun. 28, 2017.

(51) Int. Cl. B32B 27/08; B32B 5/02; B32B 7/12; B32B 27/12; B32B 27/28; B32B 27/32

(52) U.S. Cl. CPC B32B 27/08; B32B 5/022; B32B 7/12; B32B 27/12; B32B 27/285; B32B 27/32; B32B 2556/00; B32B 2307/724; B32B 2307/7265; B32B 2307/72; B32B 2398/20; B32B 2250/40; B32B 2535/00; B32B 2305/20

(57) ABSTRACT

Breathable multilayer films are provided. The multilayer films may include a monolithic core layer comprising a core-layer composition, which includes a core-layer highly breathable polymer and has a core-layer water absorption rate, and at least a first skin layer comprising a first-skin-layer composition, which includes a first-skin-layer highly breathable polymer and has a first-skin-layer water absorption rate. The core-layer water absorption rate may be at least about 10 times larger than first-skin-layer water absorption rate. Laminates including the multilayer films and at least one fibrous layer are also provided.

### PRIORITY CLAIM

This application claims priority under 35 U.S.C. § 119(e) to U.S. Provisional Application Ser. No. 62/525,883 filed Jun. 28, 2017, which is expressly incorporated by reference herein in its entirety.

### TECHNICAL FIELD

Embodiments of the presently-disclosed invention relate generally to multilayer breathable films comprising a monolithic core layer and at least a first skin layer (e.g., a monolithic skin layer). Embodiments of the presently-disclosed invention also relate generally to laminates (e.g., barrier laminates) including the multilayer breathable films disclosed herein bonded to at least a first fibrous layer.

### BACKGROUND

The infection prevention market is continuously looking for a product with a variety of properties including high breathability, softness, comfort, and high barrier properties (e.g., liquid barrier properties). Such products are often provided in a composite/laminate form comprising (i) a viral barrier film to provide breathability and prevent microorganisms (such as a virus) from penetration and (ii) at least one fibrous layer to provide physical strength. While the combination of high breathability and high liquid barrier properties is particularly important, the compatibility between the barrier film and the fibrous material is also critical for products aimed at infection control applications, such as surgical gowns and other protective apparel.

Two major types of barrier films are commonly used in the formation of breathable barrier products, namely microporous films and monolithic films. Microporous films are generally produced by dispersing finely divided particles of a non-hygroscopic inorganic salt, such as calcium carbonate, into a suitable polymer followed by forming a film of the filled polymer and stretching the film to provide good porosity and water vapor transmission. These types of films are well known for use in applications where air and moisture permeability are desired together with liquid barrier properties. However microporous films have a significant shortcoming in controlling the pore size and pore size distribution, which prevent this product from providing a consistent balance of high breathability as tested per ASTM E96D and resistance to viral penetration as tested by ASTM F1671.

Another class of breathable films is referred to as monolithic breathable films. Monolithic films are continuous and free of pores. Monolithic breathable films are capable of allowing the transfer of certain gases and water molecules due to chemical absorption, transfer through the film thickness, and release on the opposite surface.

While traditional breathable monolithic films generally have the advantages of being permeable to moisture vapor and preventing liquid penetration, they are all naturally hygroscopic. When laminated with polyolefin based materials, such as a polypropylene nonwoven, the composite product will often experience a decrease in adhesion between the monolithic film and the nonwoven once the film has absorbed moisture. The other issue with a laminate/composite made by gluing a highly breathable monolithic film to a nonwoven arises at heat sealed seams (e.g., heat sealed sleeve seams), where the seam integrity will eventually deteriorate and lose its barrier property due to poor compatibility between the nonpolar surface of the polyolefin and the highly polar surface of the film.

Therefore, there remains a need in the art for a breathable multilayer film that may be readily handled and laminated to generally non-polar substrates (e.g., polyolefin-based nonwoven) without substantial reduction in adhesion between the breathable multilayer film and the generally non-polar substrates (e.g., polyolefin-based nonwoven) even when the laminate is exposed to moisture and the breathable multilayer film becomes hydrated. Additionally, there remains a need in the art for a composite material (e.g., a laminate) comprising a breathable multilayer film that is robust in heat sealing such that a resulting seam remains good barrier properties when exposed to moisture during an ethylene oxide (ETO) sterilization process and during use in the field.

### SUMMARY OF INVENTION

One or more embodiments of the invention may address one or more of the aforementioned problems. Certain embodiments according to the invention provide breathable multilayer films including a monolithic core layer and at least one skin layer (e.g., a first skin layer). The monolithic core layer may comprise a core-layer composition, in which the core-layer composition comprises a core-layer highly breathable polymer and has a core-layer water absorption rate. The at least one skin layer may include a first skin layer comprising a first-skin-layer composition, in which the first-skin-layer composition comprises a first-skin-layer highly breathable polymer and has a first-skin-layer water absorption rate. In accordance with certain embodiments of the invention, the core-layer water absorption rate is at least about 10 times larger than first-skin-layer water absorption rate. For instance, the core-layer composition may comprise core-layer highly breathable polymer(s) that are hygroscopic and exhibit a high water absorption rate and high level of breathability while the first-skin-layer composition may comprise first-skin-layer highly breathable polymer(s) that are also hygroscopic but exhibit a water absorption rate that is less than that of the core-layer composition. In accordance with certain embodiments of the invention the breathable multilayer films comprise a second skin layer such that the monolithic core layer is directly or indirectly sandwiched between the first skin layer and the second skin layer. In accordance with certain embodiments of the invention, the first skin layer and/or the second skin layer are monolithic. The first skin layer, the second skin layer (if present), and/or the monolithic core layer, in accordance with certain embodiments of the invention, may be devoid of soft polymer having a Tg below 0° C. In accordance with certain embodiments of the invention, the breathable multilayer film comprises an average density being less than about 1.0 g/cc, such as from about 0.4 to about 0.9 g/cc, or from about 0.4 to about 0.8 g/cc, or from about 0.4 to about 0.7 g/cc, or from about 0.4 to about 0.6 g/cc. In accordance with certain embodiments of the invention, the breathable multilayer film exhibits a contact angle from about 60 to about 70 degrees as determined according to ASTM D5946, such as from about 62 to about 68 degrees, or from about 65 to about 68 degrees.

In another aspect, the invention provides a laminate comprising a breathable multilayer film as disclosed herein bonded to at least a first fibrous layer (e.g., a first nonwoven material). Laminates, in accordance with certain embodiments of the invention, may include a second fibrous layer (e.g., a second nonwoven material) such that the breathable multilayer film is directly or indirectly sandwiched between the first fibrous layer and the second fibrous layer. In accordance with certain embodiments of the invention, the breathable multilayer film may be continuously or discontinuously adhesively bonded to the first fibrous layer and/or the second fibrous layer. Laminates in accordance with certain embodiments of the invention may be incorporated within and/or form a barrier article, such as surgical gowns, surgical sleeves, surgical drapes, surgical pant legs, etc.).

In another aspect, the present invention provides a process for forming a breathable multilayer film, in which the process may comprise co-extruding a multilayer film as disclosed herein. In accordance with certain embodiments of the invention, the process may include a step of forming a core-layer polymer melt and a step for forming a first-skin-layer polymer melt. The process may comprise co-extruding the core-layer polymer melt and the first-skin-layer polymer melt to form a monolithic core layer and a first skin layer to provide the breathable multilayer film.

In yet another aspect, the present invention provides a process for forming a laminate. In accordance with certain embodiments of the invention, the process may include a step of forming a core-layer polymer melt and a step of forming a first-skin-layer polymer melt. The process may comprise co-extruding the core-layer polymer melt and the first-skin-layer polymer melt to form a monolithic core layer and a first skin layer to provide the breathable multilayer film, followed by laminating the first skin layer of the multilayer film to a first fibrous layer. In accordance with certain embodiments of the invention, the laminating step may comprise adhesively bonding the first fibrous layer to the first skin layer with a continuous layer or coating of adhesive or with a discontinuous layer or coating of adhesive.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a breathable multilayer film including one skin layer according to one embodiment of the invention;

FIG. 2 illustrates a breathable multilayer film including two skin layers according to one embodiment of the invention;

FIG. 3 illustrates a laminate including a breathable multilayer film sandwiched between a first fibrous layer and an optional second fibrous layer;

FIG. 4 illustrates a laminate including a breathable multilayer film adhesively bonded to a first fibrous layer via a first continuous adhesive layer and an optional second fibrous layer adhesively bonded to the breathable multilayer film via a second continuous adhesive layer according to one embodiment of the invention;

FIG. 5 illustrates a laminate including a breathable multilayer film adhesively bonded to a first fibrous layer via a first discontinuous adhesive layer and an optional second fibrous layer adhesively bonded to the breathable multilayer film via a second discontinuous adhesive layer according to one embodiment of the invention;

FIG. 6 illustrates a laminate including a breathable multilayer film adhesively bonded to a first fibrous layer via a first adhesive layer along only a width of the breathable multilayer film and an optional second fibrous layer adhesively bonded to the breathable multilayer film via a second adhesive layer along only the width of the breathable multilayer film according to one embodiment of the invention;

FIG. 7 illustrates a laminate including a breathable multilayer film adhesively bonded to a first fibrous layer and an optional second fibrous layer, in which the adhesive layers extend along the widths of the fibrous layers according to one embodiment of the invention; and

FIG. 8 illustrates a laminate including a breathable multilayer film adhesively bonded to a first fibrous layer and an optional second fibrous layer, in which the adhesive layer between the breathable multilayer film and the optional second fibrous layer extends along the width of the optional second fibrous layer according to one embodiment of the invention.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

This invention includes breathable multilayer films that exhibit great compatibility with generally non-polar substrates, such as polyolefin nonwoven materials. The breathable multilayer films include a highly breathable core layer (e.g., a monolithic core layer) comprising a polymer or polymer blend having a high water absorption rate and at least one skin layer comprising a highly breathable polymer or polymer blend having a substantially lower water absorption rate relative the core layer. In this regard, the at least one skin layer comprises a polymer or polymer blend that is less polar than the polymer or polymer blend of the core layer. Breathable multilayer films, according to certain embodiments of the invention, provide the advantages of being permeable to moisture vapor and preventing liquid penetration while simultaneously providing bonding compatibility with generally non-polar substrates (e.g., polyolefin nonwovens). In accordance with certain embodiments, the at least one skin layer and/or the core layer may be devoid of soft polymers having a T_{g} of 0° C. or less (e.g., materials traditionally used to improve adhesion) and such previously-referenced advantages may still be realized. When such breathable multilayer films are laminated with polyolefin based materials, such as a polypropylene nonwoven, the multilayer film may exhibit a stable adhesion to the nonwoven even when the laminate is exposed to moisture. In this regard, certain embodiments of the invention provide breathable multilayer films having improved compatibility with polyolefin-based nonwoven materials, such that heat sealed seams (e.g., sleeve seams for surgical attire) maintain acceptable barrier properties when exposed to moisture during ETO sterilization and during use in the field. In this regard, the breathable multilayer films in accordance with certain embodiments of the invention may provide desirable breathability (e.g., water vapor transmission rate), mechanical strength (e.g., tensile strength, elongation), and barrier properties (IPA solution penetration, hydro head, and viral barrier testing), while at the same time provide a good affinity to polyolefin nonwovens to ensure good peel strength and heat seal seam integrity.

Certain embodiments of the invention, for instance provide a breathable multilayer monolithic film (e.g., one or all layers of the multilayer film may be monolithic) that preferably resists blocking, has a high resistance to liquid penetration, and has improved compatibility to polyolefin nonwovens. In this regard, the breathable multilayer films exhibit high MVTR without needing to be stretched in order to develop a desirable moisture vapor transmission rate. In accordance with certain embodiments of the invention, the breathable multilayer monolithic film may comprise a core layer made from a first composition (e.g., a core-layer composition comprising a core-layer highly breathable polymer) and at least one and optionally two skin layers made from a second composition (e.g., a first-skin-layer composition and/or a second-skin-layer composition). In accordance with certain embodiments of the invention, the core layer may be disposed directly or indirectly between the first skin layer and the second skin layer (when present). In this regard, the breathable multilayer film (e.g., monolithic film) may be made by a process that melts the respective compositions and produces a multilayer film having an ‘ABA’ or a ‘BA’ structure where ‘B’ is the core layer as disclosed herein and ‘A’ are skin layers as disclosed herein. In accordance with certain embodiments of the invention, the core layer has a water absorption rate that is at least about 2 to 10 times higher than that of the skin layer or skin layers or at least about 10 times higher than that of the skin layer or skin layers. For instance, the core layer may comprise a main component consisting of a hygroscopic polymer or a blend of hygroscopic polymers (e.g., highly breathable polymer(s)) that exhibits a high water absorption rate when tested per ISO 62 and a high breathability when converted into a film. The respective compositions for the skin layer or skin layers may comprise a hygroscopic polymer or a blend of hygroscopic polymers (e.g., highly breathable polymer(s)) that exhibit a much lower water absorption rate when tested per ISO 62. In accordance with certain embodiments of the invention, the skin layer(s) may be devoid of any soft polymer(s), such as polyethylene or polypropylene, and/or any form of a pore-forming filler. In accordance with certain embodiments of the invention, the polymer or polymer blend of at leat the first skin layer may be selected as having a somewhat lesser hygroscopic nature and lesser tackiness (e.g., lower tendency to block) than the hygroscopic polymer composition of the core layer.

The terms “substantial” or “substantially” may encompass the whole amount as specified, according to certain embodiments of the invention, or largely but not the whole amount specified according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof. Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” or “polymeric” shall also include polymers made from various catalyst systems including, without limitation, the Ziegler-Natta catalyst system and the metallocene/single-site catalyst system. The term “polymer” or “polymeric” shall also include, in according to certain embodiments of the invention, polymers produced by fermentation process or biosourced.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, hydroentangling, air-laid, wet-laid, and carded-bonded web processes.

The term “staple fiber”, as used herein, may comprise a cut fiber from a filament. In accordance with certain embodiments, any type of filament material may be used to form staple fibers. For example, staple fibers may be formed from cellulosic fibers, polymeric fibers, and/or elastomeric fibers. Examples of materials may comprise cotton, rayon, wool, nylon, lyocell, polypropylene, and polyethylene terephthalate. The average length of staple fibers may comprise, by way of example only, from about 2 centimeter to about 15 centimeter.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous. It is noted that the spunbond used in certain composites of the invention may include a nonwoven described in the literature as SPINLACE®.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers are microfibers which may be continuous or discontinuous.

The term “sub-micron layer”, as used herein, may comprise a nonwoven layer including fibers having diameters of less than about 1000 nanometers (i.e., one micron). Sub-micron fiber webs may be desired, for example, due to their high surface area and low pore size, among other characteristics. Methods of producing sub-micron fibers include melt fibrillation. Melt fibrillation is a general class of fiber production in which one or more polymers are melted and extruded into many possible configurations (e.g. co-extrusion, homogeneous or multicomponent films, or filaments) and then fibrillated or fiberized into filaments. Non-limiting examples of melt fibrillation methods comprise melt blowing, melt fiber bursting, melt electro-blowing, melt circular spinning, and melt film fibrillation. Methods of producing sub-micron fibers not from melts comprise film fibrillation, electro-spinning, and solution spinning. Other methods of producing sub-micron fibers may include spinning a larger diameter multicomponent fiber in an islands-in-the-sea, segmented pie, or other configuration where the fiber is then further processed so that sub-micron fibers result (e.g., splittable fibers in which the individual components are separated from the other components to provide sub-micron fibers).

The term “layer”, as used herein, may comprise a generally recognizable combination of similar material types and/or functions existing in the X-Y plane.

As used herein, the term “proximate” in the context of the relative positioning of two particular layers of a multilayer film may comprise the positioning of a layer being one or more layers removed from another layer. For example, the term “proximate” in the context of the relative positioning of a first layer and a second layer may mean that the first and second layers may be separated by 1, 2, 3, or more intermediate layers, such as layers positioned between the core layer and a skin layer. Layers that are positioned proximate to one another are adequately positioned so as to achieve a desired construct and/or functionality.

The term “bicomponent fibers”, as used herein, may comprise fibers formed from at least two different polymers extruded from separate extruders but spun together to form one fiber. Bicomponent fibers are also sometimes referred to as conjugate fibers or multicomponent fibers. The polymers are arranged in a substantially constant position in distinct zones across the cross-section of the bicomponent fibers and extend continuously along the length of the bicomponent fibers. The configuration of such a bicomponent fiber may be, for example, a sheath/core arrangement wherein one polymer is surrounded by another, or may be a side-by-side arrangement, a pie arrangement, or an “islands-in-the-sea” arrangement, each as is known in the art of multicomponent, including bicomponent, fibers. The “bicomponent fibers” may be thermoplastic fibers that comprise a core fiber made from one polymer that is encased within a thermoplastic sheath made from a different polymer or have a side-by-side arrangement of different thermoplastic fibers. The first polymer often melts at a different, typically lower, temperature than the second polymer. In the sheath/core arrangement, these bicomponent fibers provide thermal bonding due to melting of the sheath polymer, while retaining the desirable strength characteristics of the core polymer. In the side-by-side arrangement, the fibers shrink and crimp creating z-direction expansion.

As used herein, the term “monolithic” film may comprise any film that is continuous and substantially free or free of pores (e.g., devoid of pores). In certain alternative embodiments of the invention, a “monolithic” film may comprise fewer pore structures than would otherwise be found in a microporous film. According to certain non-limiting exemplary embodiments of the invention, a monolithic film may act as a barrier to liquids and particulate matter but allow water vapor to pass through, such as by absorbing water vapor on one side of the film, transporting the water vapor through the film, and releasing the water vapor on the opposite side of the film. In addition, without intending to be bound by theory, by achieving and maintaining high breathability, it is possible to provide an article that is more comfortable to wear because the migration of water vapor through the laminate helps reduce and/or limit discomfort resulting from excess moisture trapped against the skin. Monolithic films, according to certain embodiments of the invention, may also act as barriers to bacteria and viruses and may provide an article or garment that reduces the contamination of the surroundings and the spread of infections and illness caused by the bacteria and viruses.

The term “highly breathable polymer”, as used herein, may comprise any polymer or elastomer that is selectively permeable to water vapor but substantially impermeable to liquid water and that can form a breathable film, for example, in which the polymer is capable of absorbing and desorbing water vapor and providing a barrier to aqueous fluids (e.g., water, blood, etc.). For example, a highly breathable polymer can absorb water vapor from one side of a film and release it to the other side of film, thereby allowing the water vapor to be transported through the film. As the highly breathable polymer can impart breathability to films, films formed from such polymers do not need to include pores (e.g., monolithic film). According to certain embodiments of the invention, “highly breathable polymer” may comprise any thermoplastic polymer or elastomer having a moisture vapor transmission rate (MVTR) of at least 500 g/m²/day when formed into a film, such as a film having, for example, a thickness of about 25 microns or less. According to certain embodiments of the invention, “highly breathable polymer” may comprise any thermoplastic polymer or elastomer having a MVTR of at least 750 g/m²/day or of at least 1000 g/m²/day when formed into a film, such as a film having, for example, a thickness of about 25 microns or less. According to certain embodiments of the invention, highly breathable polymers may comprise, for example, any one or combination of a polyether block amide copolymer (e.g., PEBAX® from Arkema Group), polyester block amide copolymer, copolyester thermoplastic elastomer (e.g., ARNITEL® from DSM Engineering Plastics, HYTREL® from E.I. DuPont de Nemours and Company), or thermoplastic urethane elastomer (TPU).

The term “soft polymer”, as used herein, may comprise any material that either does not allow water vapor to pass through the material or substantially impedes the movement of water vapor through the material and has a glass transition temperature (T_{g}) of about 0° C. or less, or −20° C. or less. Soft polymers generally lowers breathability, but have been used to improve adhesion and processability. Examples of soft polymers include polyolefins, polyolefin copolymers, and copolymers of one or more olefins and one or more alkyl(meth) acrylate. Examples of such polyolefins include, but are not limited to ethylene, propylene, 1-butene, 1-hexene, 1-octene or 1-decene, and mixtures thereof.

The term “laminate”, as used herein, may be a structure comprising two or more layers, such as a film layer and a fibrous layer (e.g., a woven or nonwoven fabric). The two layers of a laminate structure may be joined together to each other such that a substantial portion of their common X-Y plane interface, according to certain embodiments of the invention.

The term “co-extruding”, as used herein, may comprise a process of forming an extrudate composed of more than one distinct and different polymeric melt composition, such as in an multilayer configuration, in which each distinct and different polymeric melt composition may define a distinct and individual layer of the extrudate. For example, “co-extruding” may comprise a process of simultaneously extruding two or more distinct and different polymeric melt compositions via different extruders and passing the individual extrudates from each extruder, for example, to a single die having separate orifices arranged in such a manner that the extruded polymeric melt compositions are brought into contact to form an extrudate composed of the one or more distinct and different polymeric melt compositions. In accordance with certain embodiments of the invention, “co-extruding” is not limited to any particular type of co-extrusion technology and may include, for example, cast film processes, blown film processes, and sheet extrusion processes. In accordance with certain embodiments of the invention, a “co-extruded” film may comprise a multi-layer film formed by a “co-extruding” process.

All whole number end points disclosed herein that can create a smaller range within a given range disclosed herein are within the scope of certain embodiments of the invention. By way of example, a disclosure of from about 10 to about 15 includes the disclosure of intermediate ranges, for example, of: from about 10 to about 11; from about 10 to about 12; from about 13 to about 15; from about 14 to about 15; etc. Moreover, all single decimal (e.g., numbers reported to the nearest tenth) end points that can create a smaller range within a given range disclosed herein are within the scope of certain embodiments of the invention. By way of example, a disclosure of from about 1.5 to about 2.0 includes the disclosure of intermediate ranges, for example, of: from about 1.5 to about 1.6; from about 1.5 to about 1.7; from about 1.7 to about 1.8; etc.

I. Breathable Multilayer Films

In one aspect, the invention provides breathable multilayer films including a monolithic core layer and at least one skin layer (e.g., a first skin layer). In accordance with certain embodiments of the invention, the at least one skin layer includes a first skin layer that that may be monolithic. The monolithic core layer may comprise a core-layer composition, in which the core-layer composition comprises a core-layer highly breathable polymer and has a core-layer water absorption rate. The at least one skin layer may include a first skin layer comprising a first-skin-layer composition, in which the first-skin-layer composition comprises a first-skin-layer highly breathable polymer and has a first-skin-layer water absorption rate. In accordance with certain embodiments of the invention, the core-layer water absorption rate is at least about 10 times larger than first-skin-layer water absorption rate. For instance, the core-layer composition may comprise core-layer highly breathable polymer(s) that are hygroscopic and exhibit a high water absorption rate and high level of breathability while the first-skin-layer composition may comprise first-skin-layer highly breathable polymer(s) that are also hygroscopic but exhibit a water absorption rate that is less than that of the core-layer composition. In accordance with certain embodiments of the invention the breathable multilayer films comprise a second skin layer such that the monolithic core layer is directly or indirectly sandwiched between the first skin layer and the second skin layer. In accordance with certain embodiments of the invention, the first skin layer and/or the second skin layer are monolithic. The first skin layer, the second skin layer (if present), and/or the monolithic core layer, in accordance with certain embodiments of the invention, may be devoid of soft polymer having a T_{g} below 0° C.

In accordance with certain embodiments of the invention, the core-layer water absorption rate may comprise from at least about 10 to about 50 times larger than first-skin-layer water absorption rate, such as from at least about 10 to about 45, from at least about 10 to about 40, from at least about 10 to about 35, from at least about 10 to about 30, from at least about 10 to about 25, from at least about 10 to about 20, or from at least about 10 to about 15 times larger than first-skin-layer water absorption rate. In certain embodiments of the invention, for instance, the core-layer water absorption rate may comprise at most about any of the following: 50, 45, 40, 35, 30, 25, 20, and 15 times larger than first-skin-layer water absorption rate and/or at least about any of the following: 2, 5, 7, 10, 12, 15, and 20 times larger than first-skin-layer water absorption rate. The water absorption rate may be determined in accordance with ISO 62.

In accordance with certain embodiments of the invention, the core-layer water absorption rate comprises at least about 15% (e.g., 15-150%) as determined according to ISO 62. In certain embodiments of the invention, for instance, the core-layer water absorption rate may comprise at most about any of the following: 150%, 140%, 130%, 120%, 110%, 100%, 90%, 80%, 70%, 60%, 50%, 45%, 40%, 35%, 30%, 25%, 20%, and 15% as determined according to ISO 62 and/or at least about any of the following: 2%, 5%, 7%, 10%, 12%, 15%, 20%, 25%, 30%, 35%, 40%, 45% and 50% as determined according to ISO 62 (e.g., from about 15% to about 150%, from about 15% to about 50%, from about 15% to about 35%, or from about 15% to about 30% as determined according to ISO 62).

The first-skin-layer water absorption rate, in accordance with certain embodiments of the invention, may comprises less than about 5% as determined according to ISO 62 (e.g., from about 5% to about 0.5% as determined according to ISO 62). In certain embodiments of the invention, for instance, the first-skin-layer water absorption rate may comprise at most about any of the following: 5%, 4.5%, 4.0%, 3.5%, 3.0%, 2.5%, 2.0%, and 1.5% as determined according to ISO 62 and/or at least about any of the following: 0.5%, 0.7%, 0.9%, 1.0%, 1.2%, and 1.5% as determined according to ISO 62 (e.g., from about 5% to about 0.5%, from about 4% to about 0.5%, from about 3% to about 0.5%, or from about 2% to about 0.5% as determined according to ISO 62).

In accordance with certain embodiments of the invention, the core-layer humidity (e.g., moisture) absorption rate may comprise from at least about 5 to about 30 times larger than first-skin-layer humidity (e.g., moisture) absorption rate, such as from at least about 5 to about 25, from at least about 10 to about 20, or from at least about 15 to about 20 times larger than first-skin-layer humidity (e.g., moisture) absorption rate. In certain embodiments of the invention, for instance, the core-layer humidity (e.g., moisture) absorption rate may comprise at most about any of the following: 35, 30, 25, 20, and 18 times larger than the first-skin-layer humidity (e.g., moisture) absorption rate and/or at least about any of the following: 5, 8, 10, 12, 15, and 16 times larger than first-skin-layer humidity (e.g., moisture) absorption rate. The water absorption rate may be determined in accordance with ISO 62.

In accordance with certain embodiments of the invention, the core-layer humidity (e.g., moisture) absorption rate comprises at least about 1% (e.g., 1-10%) as determined according to ISO 62. In certain embodiments of the invention, for instance, the core-layer humidity (e.g., moisture) absorption rate may comprise at most about any of the following: 10%, 8%, 7%, 6%, 5%, and 4% as determined according to ISO 62 and/or at least about any of the following: 1%, 2%, 3%, 4%, and 5% as determined according to ISO 62.

The first-skin-layer humidity (e.g., moisture) absorption rate, in accordance with certain embodiments of the invention, may comprises less than about 1% as determined according to ISO 62 (e.g., from about 1% to about 0.1% as determined according to ISO 62). In certain embodiments of the invention, for instance, the first-skin-layer humidity (e.g., moisture) absorption rate may comprise at most about any of the following: 1%, 0.9%, 0.8%, 0.7%, 0.6%, 0.5%, 0.4%, and 0.3% as determined according to ISO 62 and/or at least about any of the following: 0.1%, 0.2%, 0.25%, 0.3%, and 0.4% as determined according to ISO 62.

In accordance with certain embodiments of the invention, the breathable multilayer film also includes a second skin layer (e.g., a second skin monolithic layer), in which the monolithic core layer is directly or indirectly sandwiched between the first skin layer and the second skin layer. For example, the core layer may comprise a top surface and a bottom surface, and the first skin layer may be positioned above and at least one of proximate or adjacent to at least a portion of the top surface of the core layer while the second skin layer may be positioned below and at least one of proximate or adjacent to at least a portion of the bottom surface of the core layer. In such embodiments of the invention, the second skin layer may comprise a second-skin-layer composition that may be the same or different from the first-skin-layer composition. The second-skin-layer composition, for instance, may comprise a second-skin-layer highly breathable polymer and has a second-skin-layer water absorption rate, in which the core-layer water absorption rate is at least about 10 times larger than second-skin-layer water absorption rate.

In accordance with certain embodiments of the invention, the core-layer water absorption rate may comprise from at least about 10 to about 50 times larger than second-skin-layer water absorption rate, such as from at least about 10 to about 45, from at least about 10 to about 40, from at least about 10 to about 35, from at least about 10 to about 30, from at least about 10 to about 25, from at least about 10 to about 20, or from at least about 10 to about 15 times larger than second-skin-layer water absorption rate. In certain embodiments of the invention, for instance, the core-layer water absorption rate may comprise at most about any of the following: 50, 45, 40, 35, 30, 25, 20, and 15 times larger than second-skin-layer water absorption rate and/or at least about any of the following: 2, 5, 7, 10, 12, 15, and 20 times larger than second-skin-layer water absorption rate. The water absorption rate may be determined in accordance with ISO 62.

The second-skin-layer water absorption rate, in accordance with certain embodiments of the invention, may comprises less than about 5% as determined according to ISO 62 (e.g., from about 5% to about 0.5% as determined according to ISO 62). In certain embodiments of the invention, for instance, the second-skin-layer water absorption rate may comprise at most about any of the following: 5%, 4.5%, 4.0%, 3.5%, 3.0%, 2.5%, 2.0%, and 1.5% as determined according to ISO 62 and/or at least about any of the following: 0.5%, 0.7%, 0.9%, 1.0%, 1.2%, and 1.5% as determined according to ISO 62 (e.g., from about 5% to about 0.5%, from about 4% to about 0.5%, from about 3% to about 0.5%, or from about 2% to about 0.5% as determined according to ISO 62).

In accordance with certain embodiments of the invention, the core-layer humidity (e.g., moisture) absorption rate may comprise from at least about 5 to about 30 times larger than second-skin-layer humidity (e.g., moisture) absorption rate, such as from at least about 5 to about 25, from at least about 10 to about 20, or from at least about 15 to about 20 times larger than second-skin-layer humidity (e.g., moisture) absorption rate. In certain embodiments of the invention, for instance, the core-layer humidity (e.g., moisture) absorption rate may comprise at most about any of the following: 35, 30, 25, 20, and 18 times larger than the second-skin-layer humidity (e.g., moisture) absorption rate and/or at least about any of the following: 5, 8, 10, 12, 15, and 16 times larger than the second-skin-layer humidity (e.g., moisture) absorption rate. The water absorption rate may be determined in accordance with ISO 62.

In accordance with certain embodiments of the invention, the core-layer humidity (e.g., moisture) absorption rate comprises at least about 1% (e.g., 1-10%) as determined according to ISO 62. In certain embodiments of the invention, for instance, the core-layer humidity (e.g., moisture) absorption rate may comprise at most about any of the following: 10%, 8%, 7%, 6%, 5%, and 4% as determined according to ISO 62 and/or at least about any of the following: 1%, 2%, 3%, 4%, and 5% as determined according to ISO 62.

The second-skin-layer humidity (e.g., moisture) absorption rate, in accordance with certain embodiments of the invention, may comprises less than about 1% as determined according to ISO 62 (e.g., from about 1% to about 0.1% as determined according to ISO 62). In certain embodiments of the invention, for instance, the second-skin-layer humidity (e.g., moisture) absorption rate may comprise at most about any of the following: 1%, 0.9%, 0.8%, 0.7%, 0.6%, 0.5%, 0.4%, and 0.3% as determined according to ISO 62 and/or at least about any of the following: 0.1%, 0.2%, 0.25%, 0.3%, and 0.4% as determined according to ISO 62.

In accordance with certain embodiments of the invention, the core-layer highly breathable polymer, the first-skin-layer highly breathable polymer, and/or the second-skin-layer highly breathable polymer may comprise at least one of a thermoplastic urethane (TPU), a polyether block amide copolymer (e.g., PEBAX® from Arkema Group or Vetsamid®E from Evonik), or a copolyester thermoplastic elastomer (e.g., ARNITEL® from DSM Engineering Plastics, HYTREL® from E.I. DuPont de Nemours and Company). In certain embodiments of the invention, for example, the core-layer highly breathable polymer comprises or consists of a polyether-block-ester copolymer including (i) soft blocks comprising polyethylene glycol and (ii) hard blocks comprising polybutylterephthalate.

In accordance with certain embodiments of the invention, at least one of the first-skin-layer composition, the second-skin-layer composition, and/or the core-layer composition may be substantially free of or devoid of a soft polymer as disclosed herein. The breathable multilayer film, in accordance with certain embodiments of the invention, may be comprise or consist of all individual layers of the multilayer film being substantially free of or devoid of a soft polymer (e.g., polymers having a T_{g} below 0° C. as described above). In accordance with certain embodiments of the invention, the breathable multilayer films may still exhibit desirable compatibility with generally non-polar substrates (e.g., polyolefin nonwovens) for providing strong and durable bonds thereto despite not incorporating one or more soft polymers (e.g., within the first or second skin layers).

In accordance with certain embodiments of the invention, at least one of the first-skin-layer composition, the second-skin-layer composition, and/or the core-layer composition may be substantially free of or devoid of a pore-forming filler. In this regard, the breathable multilayer films provide desirably high MVTR properties despite not having a microporous structure associated with stretched films including pore-forming fillers. For example, the breathable multilayer films may comprise an MVTR of at least 700 g/m²/day as determined by ASTM Test Method E-96D, such as at least about 900 g/m²/day, or 1000 g/m²/day, or 1300 g/m²/day as determined by ASTM Test Method E-96D. In certain embodiments of the invention, for instance, the breathable multilayer films may comprise a MVTR comprising at most about any of the following: 2000, 1800, 1600, 1500, 1300, 1200 and 1100 as determined according to by ASTM Test Method E-96D and/or at least about any of the following: 500, 700, 800, 900, 1000, and 1000 as determined by ASTM Test Method E-96D.

In accordance with certain embodiments of the invention, the breathable multilayer film may comprise a basis weight from about 5 to about 30 gsm, such as from about 10 to about 20 gsm or from about 10 to about 15 gsm. In accordance with certain embodiments of the invention, the breathable multilayer film may comprise a basis weight from at least about any of the following: 5, 10, 11, 12, 15, and 20 gsm and/or at most about 50, 40, 35, 30, 25, 20, 18, and 15 gsm. In accordance with certain embodiments of the invention, the breathable multilayer film comprises no more than 50% by weight (e.g., no more than 25%, 20%, 10% or 5% by weight) of the first skin layer, the second skin layer, or an aggregate of the first skin layer and the second skin layer. Stated somewhat differently, the first skin layer, the second skin layer, or an aggregate of the first skin layer and the second skin layer may not account for more than 50% (e.g., no more than 25%, 20%, 10% or 5%) of the total weight of the breathable film according to certain embodiments of the invention. In accordance with certain embodiments of the invention, the breathable multilayer film may comprise an ‘AB’ or ‘ABA’ structure in which the A:B weight ratio comprises a range from 3:97 to 50:50 (e.g., 5:95 to 50:50, 10:90 to 50:50, 15:85 to 50:50, 20:80 to 50:50, etc.).

The breathable multilayer film, in accordance with certain embodiments of the invention, may comprise a thickness from about 10 microns to about 50 microns, such as from about 10 microns to about 30 microns, or from about 10 microns to about 25 microns, or from about 10 microns to about 20 microns. In accordance with certain embodiments of the invention, the breathable multilayer film may comprise a thickness from at least about any of the following: 8, 10, 12, 15, and 20 microns and/or at most about 50, 40, 35, 30, 25, 20, 18, and 15 microns.

In accordance with certain embodiments of the invention, the core layer comprises a core-layer thickness, the first skin layer comprises a first-skin-layer thickness, the second skin layer comprises a second-skin-layer thickness, and the core-layer thickness is greater than each of the first-skin-layer thickness and the second-skin-layer thickness. The core-layer thickness, according to certain embodiments of the invention, may be greater than an aggregate of the first-skin-layer thickness and the second-skin-layer thickness. For instance, the core-layer thickness may account for about 50% to about 95% of the total thickness of the breathable multilayer film. In accordance with certain embodiments of the invention, the core-layer thickness may account for at least about any of the following: 40%, 50%, 60%, and 70% of the total thickness of the breathable multilayer film and/or at most about 95%, 90%, 80%, 75%, 70%, and 65% of the total thickness of the breathable multilayer film.

As noted above, the breathable multilayer film (e.g., monolithic film) may comprise, in accordance with certain embodiments of the invention, an ‘AB’ or ‘ABA’ structure in which distinct characteristics between the ‘A’ and ‘B’ layers. By way of example only, the ‘A’ layer(s) may comprise a water absorption rate less than 5% according to test method ISO 62, in which the composition forming these layers comprise or consist of thermoplastic polyurethanes (TPU), polyether-block-esters, polyether-block-amides, and polyester-block-amide elastomers. The B layer, for example, may comprise a moisture/water absorption rate higher than 25% according to test method ISO 62, in which the composition forming this layer comprises or consists of thermoplastic polyurethanes (TPU), polyether-block-esters, polyether-block-amides and polyester-block-amide elastomers. However, the composition forming the ‘B’ layer may be more hygroscopic or polar than the composition forming the ‘A’ layer(s). Stated somewhat differently, the polymer(s) in the ‘A’ layer may be generally (or overall) less polar than those of the ‘B’ layer. As such, the ‘A’ layers are much less hygroscopic having a water absorption less significantly less than that of the ‘B’ layer as disclosed herein. This low polarity relative to the ‘B’ layer improves the breathable multilayer films compatibility (e.g., ability to bond) with, for example, a polypropylene based nonwoven. This feature, for example, enables a strong adhesion when fused by heat sealing for formation of a seam. Additionally, the ‘A’ layer(s) absorb very low amount of moisture when exposed to testing solutions, ETO sterilization processes, or body fluids. In accordance with certain embodiments of the invention, the breathable multilayer film comprises a co-extruded monolithic film (e.g., does not comprise a microporous layer).

In accordance with certain embodiments of the invention, the average density of the breathable multilayer film may be less than 1.0 g/cc. By way of example only, if the overall or total thickness of 12 gsm breathable multilayer film ranges from 20 microns to 30 microns, then the overall average film density is calculated as follows: Density (g/cc)=basis weight (gsm)/thickness (micrometer). Therefore, the overall average film density would range from about 0.4 to about 0.6 g/cc (e.g., less than 1 g/cc). In accordance with certain embodiments of the invention, the average density of the breathable multilayer film may comprise from at least about any of the following: 0.3, 0.35, 0.4, 0.45, 0.5, 0.55, 0.6, 0.65, and 0.7 g/cc and/or at most about 1, 0.95, 0.9, 0.85, 0.8, 0.75, 0.7, 0.65, and 0.6 g/cc.

In accordance with certain embodiments of the invention, the breathable multilayer film may exhibit a contact angle from about 60 to about 70 degrees as determined according to ASTM D5946. From a polarity viewpoint for a given film, contact angle is an indirect measurement of a material surface energy. In this regard, the higher the surface energy of the solid material (e.g., film surface), the lower the contact angle of a water droplet. In accordance with certain embodiments of the invention, for example, the breathable multilayer film may exhibit a contact angle from at least about 60, 61, 62, 63, 64, and 65 degrees as determined according to ASTM D5946 and/or at most about 70, 69, 68, 67, 66, and 65 degrees as determined according to ASTM D5946.

In accordance with certain embodiments of the invention, at least the first skin layer is less tacky than the monolithic core layer and/or the second skin layer, if present. In accordance with certain embodiments of the invention the first skin layer and the second skin layer are each less tacky than the monolithic core layer. Given the same or similar surface morphology, for instance, film layers made from a higher water absorption resin is more tacky than a film layer made from a lower water absorption resin. In this regard, the first skin layer and/or the second skin layer are formed from compositions (e.g., first-skin-layer composition, and/or second-skin-layer composition) that are much less polar than the composition forming the monolithic core layer and have much lower water absorption rate in comparison to the water absorption rate of the monolithic core layer. As such, the first skin layer and/or the second skin layer are, in accordance with certain embodiments of the invention, less tacky than the monolithic core layer.

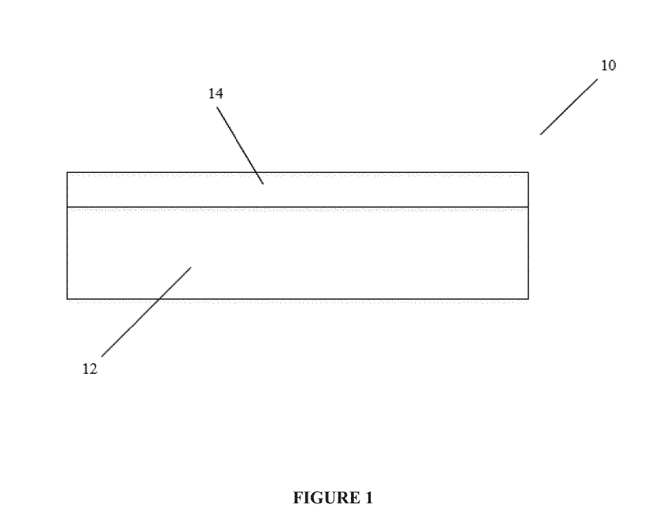

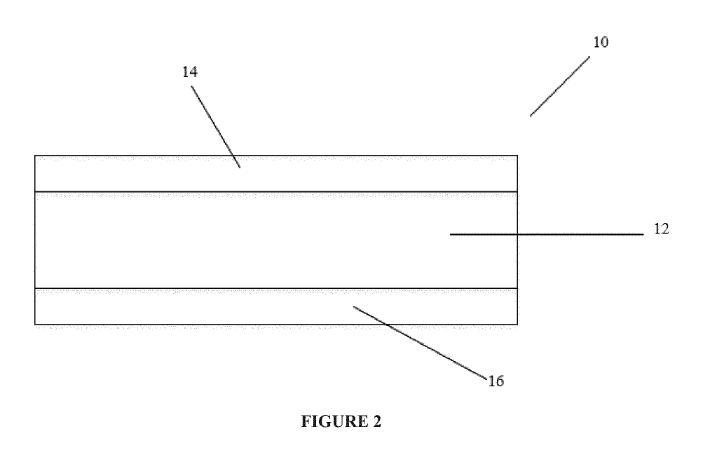

FIG. 1 illustrates a multilayer breathable film 10 having an ‘AB’ structure in which the ‘B’ layer comprises a monolithic core layer 12 and the ‘A’ layer comprises a monolithic first skin layer 14. FIG. 2 illustrates a multilayer breathable film 10 having an ‘ABA’ structure in which the ‘B’ layer comprises a monolithic core layer 12 and the ‘A’ layers comprises a monolithic first skin layer 14 and a monolithic second skin layer 16.

In another aspect, the invention provides processes for forming a breathable multilayer film comprising a step of co-extruding breathable multilayer film as disclosed herein. In accordance with certain embodiments of the invention, the process may comprise a step of forming a core-layer polymer melt, a step of forming a first-skin-layer polymer melt, and co-extruding the core-layer polymer melt and the first-skin-layer polymer melt to form a monolithic core layer and a first skin layer (e.g., monolithic) and combining the monolithic core layer and a first skin layer (e.g., monolithic) to form the breathable multilayer film. In accordance with certain embodiments of the invention, the process may further comprise a steps of forming a second-skin-layer polymer melt, co-extruding the core-layer polymer melt, the first-skin-layer polymer melt, and the second-skin-layer polymer melt to form the monolithic core layer, the first skin layer (e.g., monolithic), a second skin layer (e.g., monolithic), and combining the three layers to form the breathable multilayer film.

II. Laminates Including Breathable Multilayer Films

The invention also provides a laminate comprising a breathable multilayer film as disclosed herein, in which the breathable multilayer film may be directly or indirectly bonded to at least a first fibrous layer (e.g., a first nonwoven material). Laminates, in accordance with certain embodiments of the invention, may include a second fibrous layer (e.g., a second nonwoven material) such that the breathable multilayer film is directly or indirectly sandwiched between the first fibrous layer and the second fibrous layer. In accordance with certain embodiments of the invention, the breathable multilayer film may be continuously or discontinuously adhesively bonded to the first fibrous layer and/or the second fibrous layer. Laminates in accordance with certain embodiments of the invention may be incorporated within and/or form a barrier article, such as surgical gowns, surgical sleeves, surgical drapes, surgical pant legs, etc.).

The first nonwoven material and/or the second nonwoven material (if present) may comprise a spunbond layer, a meltblown layer, a sub-micron layer, or any combination thereof. In accordance with certain embodiments of the invention, for example, the first nonwoven material and/or the second nonwoven material (if present) may comprise spunbond-containing nonwovens, meltblown-containing nonwovens, hydroentangled or hydroentangled-containing nonwovens, air-laid or air-laid-containing nonwovens, bonded carded or bonded carded-containing nonwovens, or any combination thereof. For example, the first nonwoven material and/or the second nonwoven material (if present) may independently comprise a spunbond nonwoven or a spunbond-meltblown-spunbond (SMS) nonwoven. By way of example only, the first fibrous layer may comprise a spunbond layer and the second fibrous layer may comprise a SMS nonwoven. In accordance with certain embodiments of the invention, first nonwoven material and/or the second nonwoven material (if present) may comprise one or more polymeric materials. For example, the first nonwoven material and/or the second nonwoven material (if present) may comprise filaments comprising a polypropylene, polyethylene, or both. In certain embodiments of the invention, for instance, the polymeric material may comprise high density polypropylene or high density polyethylene, low density polypropylene or low density polyethylene, linear low density polypropylene or linear low density polyethylene, a copolymer of polypropylene or ethylene, and any combination thereof. In certain embodiments of the invention, for instance, the polymeric material may comprise polypropylene of one or more different forms, such as a homopolymer, a random copolymer, a polypropylene made with a Ziegler-Natta or metallocene or other catalyst system. The polypropylene may be provided in a variety of configurations including isotactic, syndiotactic, and atactic configurations of polypropylene. In some embodiments of the invention, the polymeric material may comprise at least one of a polypropylene, a polyethylene, a polyester, a polyamide, or combinations thereof. In accordance with certain embodiments of the invention, the polymeric material may comprise a biopolymer (e.g., polylactic acid (PLA), polyhydroxyalkanoates (PHA), and poly(hydroxycarboxylic) acids). In accordance with certain embodiments of the invention, the first nonwoven material and/or the second nonwoven material (if present) may comprise multicomponent fibers, such as bicomponent fibers having a sheath-core configuration. For example, certain embodiments of the invention may comprise bicomponent fibers comprising a sheath comprising, by way of example only, a polyethylene or a propylene and a core comprising, by way of example only, at least one of a polypropylene, a polyethylene, a polyester, or a biopolymer (e.g., polylactic acid (PLA) polyhydroxyalkanoates (PHA), and poly(hydroxycarboxylic) acids. The first nonwoven material and/or the second nonwoven material (if present) may comprise filaments or fibers comprising a round cross-section, non-round cross section (e.g., ribbon shaped, trilobal shaped, etc.), or combinations thereof. In accordance with certain embodiments of the invention, the first nonwoven material and/or the second nonwoven material (if present) may be untreated or treated with one or more additives, such as a repellent and/or an antistatic finish.

In accordance with certain embodiments of the invention, the laminate (e.g., a breathable multilayer film, a first nonwoven material, and optionally a second nonwoven material) may comprise a basis weight from at least about any of the following: 20, 25, 30, 35, 40, 45, 50, and 55 gsm and/or at most about 100, 90, 80, 75, 70, 65, 60, and 55 gsm (e.g., from about 20 to about 65 gsm.

In accordance with certain embodiments of the invention, the first nonwoven material and/or the second nonwoven material (if present) may naturally or otherwise be rendered hydrophobic by one or more additives. In this regard, the first nonwoven material and/or the second nonwoven material (if present) may be or rendered non-absorbent (e.g., repels or at least does not attract polar liquids such as water). In accordance with certain embodiments of the invention, for example, the first nonwoven material and/or the second nonwoven material (if present) may be water and alcohol repellent. In accordance with certain embodiments of the invention, the first nonwoven material and/or the second nonwoven material (if present) my optionally comprise a repellent composition disposed thereon. For example, the repellent composition may comprise a material or materials that repel a liquid, such as water and/or blood. In this regard, the repellent composition may comprise a hydrophobic additive. In accordance with certain embodiments of the invention, the repellent composition may be provided at an amount sufficient to exhibit at least the necessary level of alcohol repellency for surgical applications. In this regard, the first nonwoven material and/or the second nonwoven material (if present) may comprise a topically or internally (e.g., via melt additive(s)) treated fabric comprising a desired alcohol repellency. In accordance with certain embodiments, the repellent composition may comprise at least one fluorochemical. For example, the at least one fluorochemical may comprise at least one of a C4 fluorochemical, a C6 fluorochemical, a C8 fluorochemical, a C10 fluorochemical, or any combination thereof.

In accordance with certain embodiments of the invention, the breathable multilayer film and at least the first fibrous layer may be laminated (e.g., bonded) together via a first adhesive layer positioned between the breathable multilayer film and the first fibrous layer. In accordance with certain embodiments of the invention, the first adhesive layer may comprise a continuous or discontinuous coating of an adhesive. In embodiments of the invention including a discontinuous coating of an adhesive, the discontinuous coating of adhesive may comprise a fiberized or nebulized hot-melt adhesive. In accordance with certain embodiments of the invention, the discontinuous coating of adhesive may comprises an aqueous or solvent-based adhesive. The discontinuous coating of adhesive, according to certain embodiments of the invention, may comprise an adhesive pattern (e.g., regularly placed adhesive) or random disposed between the breathable multilayer film and, for example, the first fibrous layer. In accordance with certain embodiments, the first adhesive layer may comprise a continuous coating of adhesive (e.g., hot-melt adhesive, solvent-based adhesive, or aqueous-based adhesive). In accordance with certain embodiments, the breathable multilayer film may not utilize an adhesive and instead be melt-extruded directly onto the first fibrous layer.

In accordance with certain embodiments of the invention, the laminate may further comprise a second fibrous layer (e.g., a second nonwoven material) as noted above. In this regard, the breathable multilayer film may be directly or indirectly sandwiched between the first fibrous layer and the second fibrous layer. In accordance with such embodiments of the invention, the breathable multilayer film and the second fibrous layer are laminated via a second adhesive layer positioned between the breathable multilayer film and the second fibrous layer. In this regard, the second adhesive layer may comprise an adhesive that is the same or different than that of the first adhesive layer. In accordance with certain embodiments of the invention, the second adhesive layer may comprise a continuous or discontinuous coating of an adhesive. In embodiments of the invention including a discontinuous coating of an adhesive, the discontinuous coating of adhesive may comprise a fiberized or nebulized hot-melt adhesive. In accordance with certain embodiments of the invention, the discontinuous coating of adhesive may comprises an aqueous or solvent-based adhesive. The discontinuous coating of adhesive, according to certain embodiments of the invention, may comprise an adhesive pattern (e.g., regularly placed adhesive) or random disposed between the breathable multilayer film and, for example, the second fibrous layer. In accordance with certain embodiments, the second adhesive layer may comprise a continuous coating of adhesive (e.g., hot-melt adhesive, solvent-based adhesive, or aqueous-based adhesive). In accordance with certain embodiments, the breathable multilayer film may not utilize an adhesive and instead be melt-extruded directly onto and/or between the first fibrous layer and second fibrous layer.

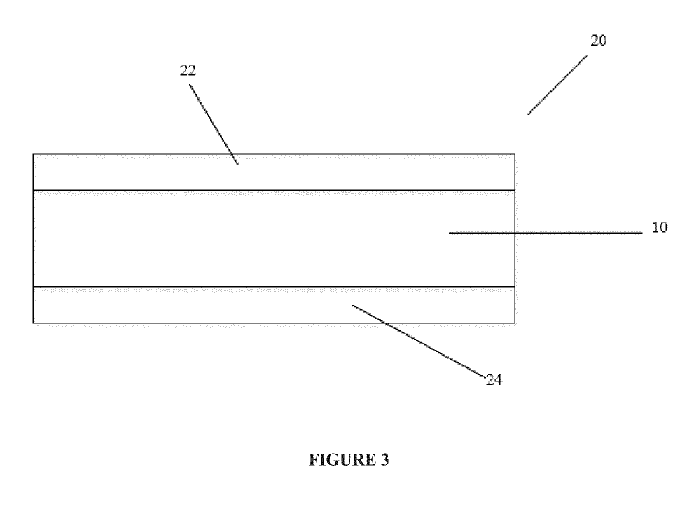

By way of example only, one example embodiment may comprise a laminate including a breathable multilayer film that is monolithic and is sandwiched between a first fibrous layer (e.g., first nonwoven) and a second fibrous layer (e.g., second nonwoven). In this particular example embodiment, each of the fibrous layers may comprise a nonwoven layer formed from polypropylene (e.g., from a formulation that comprises mainly isotactic polypropylene having a viscosity of 35±5 MFR for spunbond grade resins and a viscosity ranged from 300-2000 MFR for melt blown grade resins as measured by ISO 1133 (230° C. and 2.16 Kg). Such nonwovens can be made on Reicofil spunmelt production equipment sold by Reifenhauser Reicofil, Troisdorf, Germany. The first nonwoven layer, the breathable multilayer film, and the second nonwoven layer may be adhesively bonded together, in which the adhesive systems (e.g., a first adhesive layer and a second adhesive layer) may include hot melt adhesives (e.g., SBS-based adhesive formulations), cold glues, and water-based acrylic adhesives. FIG. 3 illustrates such an example laminate 20 including a breathable multilayer film 10 sandwiched between a first fibrous layer 22 and an optional second fibrous layer 24.

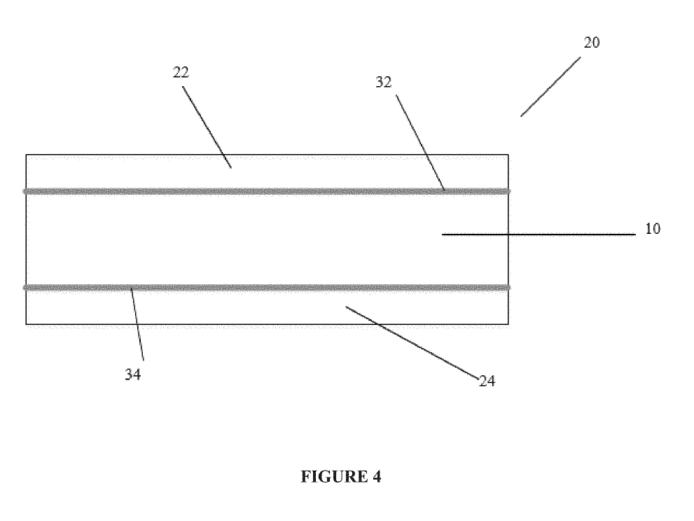

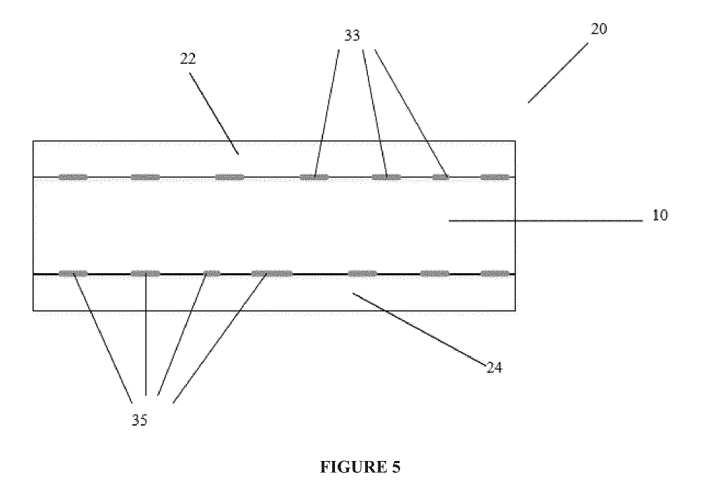

In accordance with certain embodiments of the invention, the breathable multilayer film and the first fibrous layer and/or the second fibrous layer (if present) each have substantially the same width and are adhesively bonded together (e.g., via continuous or discontinuous adhesive layer(s)) along the entire width of the laminate. In this regard, such embodiments comprising only the first fibrous layer may be referred to as a bi-laminate having full lamination (e.g., laminated along the entire width of the laminate). Similarly, such embodiments comprising both the first fibrous layer and the second fibrous layer may be referred to as a tri-laminate having full lamination (e.g., laminated along the entire width of the laminate). FIG. 4, for example, illustrates a tri-laminate 20 having full lamination (e.g., laminated along the entire width of the laminate). As shown in FIG. 4, the tri-laminate 20 includes a breathable multilayer film 10 sandwiched between a first fibrous layer 22 and a second fibrous layer 24. As also shown in FIG. 4, the breathable multilayer film 10 is adhesively bonded to the first fibrous layer 22 via a first continuous adhesive layer 32 positioned between the breathable multilayer film and the first fibrous layer. Similarly, the breathable multilayer film 10 is adhesively bonded to the second fibrous layer 24 via a first continuous adhesive layer 34 positioned between the breathable multilayer film and the second fibrous layer. As also illustrated in FIG. 4, the adhesive layers 32,34 extend along the entire width of the laminate 20, in which the breathable multilayer film 10, the first fibrous layer 22, and the second fibrous layer 24 comprise substantially the same width. FIG. 5 illustrates a similar laminate 20. The laminate 20 shown in FIG. 5, however, utilizes a discontinuous first adhesive layer 33 and a discontinuous second adhesive layer 35, in which the adhesive layers extend substantially the entire width of the laminate.

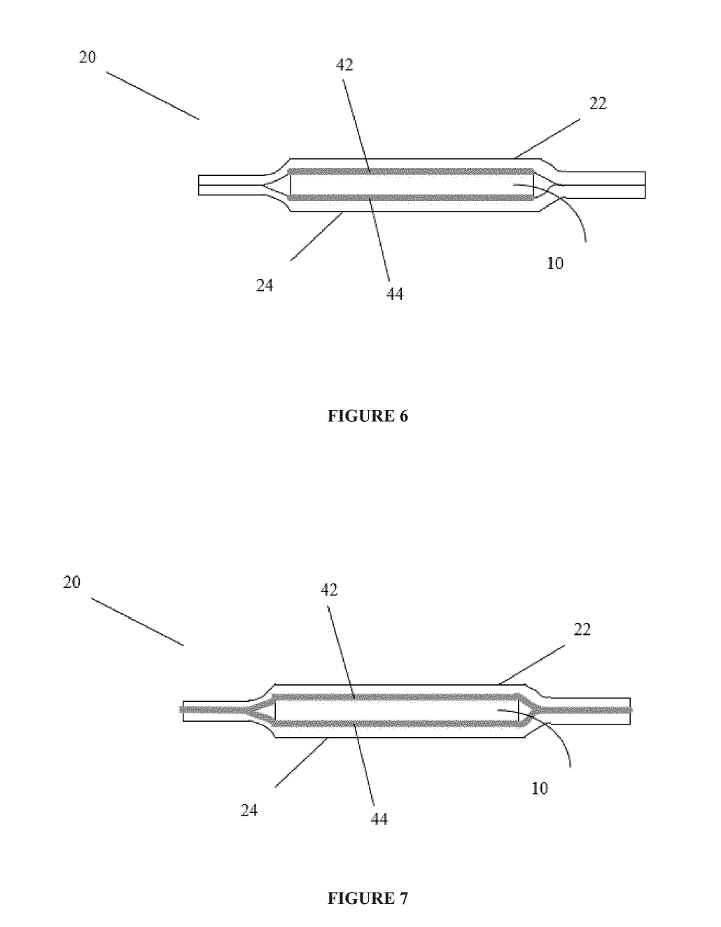

In accordance with certain embodiments of the invention, the breathable multilayer film may comprise a substantially different width than the first fibrous layer and/or the second fibrous layer (if present). For example, the width of the breathable multilayer film may be smaller than a width associated with the first fibrous layer and/or the second fibrous layer (if present). In accordance with certain embodiments of the invention, the breathable multilayer film may be adhesively bonded to the first fibrous layer (e.g., via continuous or discontinuous adhesive layer) along only the width of the breathable multilayer film and, if present, the breathable multilayer film may be adhesively bonded to the second fibrous layer (e.g., via continuous or discontinuous adhesive layer) along only the width of the breathable multilayer film. In this regard, such embodiments comprising only the first fibrous layer may be referred to as a bi-laminate zoned lamination article. Similarly, such embodiments comprising both the first fibrous layer and the second fibrous layer may be referred to as a tri-laminate zoned lamination article. FIG. 6, for example, illustrates a tri-laminate zoned lamination article. As shown in Figure, the laminate 20 includes a breathable multilayer film 10 sandwiched between a first fibrous layer 22 and a second fibrous layer 24. As also illustrated by FIG. 6, the laminate 20 includes a first adhesive layer 42 between the breathable multilayer film 10 and the first fibrous layer 22. The laminate 20 also includes a second adhesive layer 44 between the breathable multilayer film 10 and the second fibrous layer 24. The example embodiment illustrated in FIG. 6 includes a breathable multilayer film 10 that has a width that is substantially less than the width of both the first fibrous layer 22 and the second fibrous layer 24. As also shown in FIG. 6, the first adhesive layer 42 and second adhesive layer each extend only along the length of the breathable multilayer film 10.

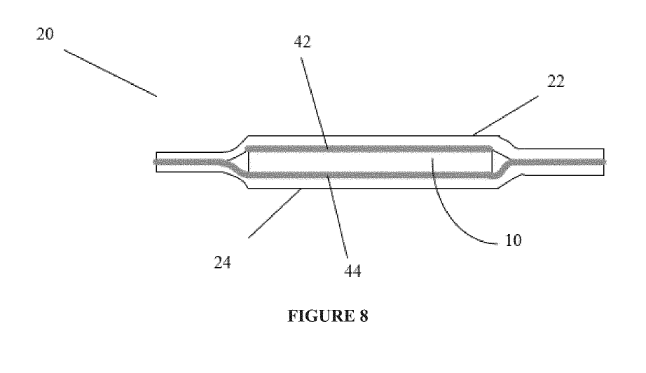

In accordance with certain embodiments of the invention, the breathable multilayer film may be sandwiched between two fibrous layers with an adhesive layer positioned between the breathable multilayer film and each of the fibrous layers. The breathable multilayer film may comprise a width that is substantially narrower than a width of a first fibrous layer and/or a width of a second fibrous layer (if present). In accordance with certain embodiments of the invention, the breathable multilayer film may be adhesively bonded to the first fibrous layer (e.g., via continuous or discontinuous adhesive layer) along the width of the breathable multilayer film and, if present, the breathable multilayer film may be adhesively bonded to the second fibrous layer (e.g., via continuous or discontinuous adhesive layer) along the width of the breathable multilayer film. In accordance with such embodiments of the invention, the adhesive layer(s) may also extend along the width of the fibrous layers. As such, a portion of the fibrous layer may be directly adhered to each other at portions where the breathable multilayer film is not present. In this regard, such embodiments comprising only the first fibrous layer may also be referred to as a bi-laminate zoned lamination article. Similarly, such embodiments comprising both the first fibrous layer and the second fibrous layer may also be referred to as a tri-laminate zoned lamination article. FIG. 7, for example, illustrates such a tri-laminate zoned lamination article. Figure illustrates a laminate 20 that includes a breathable multilayer film 10 sandwiched between a first fibrous layer 22 and a second fibrous layer 24. As also illustrated by FIG. 7, the laminate 20 includes a first adhesive layer 42 between the breathable multilayer film 10 and the first fibrous layer 22. The laminate 20 also includes a second adhesive layer 44 between the breathable multilayer film 10 and the second fibrous layer 24. The example embodiment illustrated in FIG. 7 includes a breathable multilayer film 10 that has a width that is substantially less than the width of both the first fibrous layer 22 and the second fibrous layer 24. As also shown in FIG. 7, the first adhesive layer 42 and second adhesive layer 44 each extend along the length of the laminate 20 such that at least the first fibrous layer and the second fibrous layer are directly adhered together at portions where the multilayer breathable film is not present. FIG. 8 illustrates a laminate 20 that includes a breathable multilayer film 10 sandwiched between a first fibrous layer 22 and a second fibrous layer 24. As also illustrated by FIG. 7, the laminate 20 includes a first adhesive layer 42 between the breathable multilayer film 10 and the first fibrous layer 22. The laminate 20 also includes a second adhesive layer 44 between the breathable multilayer film 10 and the second fibrous layer 24. The example embodiment illustrated in FIG. 8 includes a breathable multilayer film 10 that has a width that is substantially less than the width of both the first fibrous layer 22 and the second fibrous layer 24. As also shown in FIG. 8, the first adhesive layer 42 extends only along the width of the breathable multilayer film 10 and second adhesive layer 44 each extend along the length of the laminate 20 such that at least the first fibrous layer and the second fibrous layer are directly adhered together at portions where the multilayer breathable film is not present.

In accordance with certain embodiments of the invention, the laminates may be incorporated into or provided in the form of a barrier article, such as surgical gowns, sleeves, surgical drapes, pant legs, shoe covers, a head-piece, protective apron, or facemask. As such, certain embodiments of the invention may provide a protective apparel or a portion thereof comprising a laminate as disclosed herein. In this regard, laminates in accordance with certain embodiments of the invention may provide a barrier articles suitable for AAMI 4-rated barrier laminates.

In yet another aspect, the invention provides a process for forming a laminate. In accordance with certain embodiments of the invention, the process may include a step of forming a core-layer polymer melt and a step of forming a first-skin-layer polymer melt. The process may comprise co-extruding the core-layer polymer melt and the first-skin-layer polymer melt to form a monolithic core layer and a first skin layer to provide the breathable multilayer film, followed by laminating the first skin layer of the multilayer film to a first fibrous layer. In accordance with certain embodiments of the invention, the laminating step may comprise adhesively bonding the first fibrous layer to the first skin layer with a continuous layer or coating of adhesive or with a discontinuous layer or coating of adhesive. In accordance with certain embodiments of the invention, the process may also comprise a step of forming a second-skin-layer polymer melt and a step of co-extruding the core-layer polymer melt, the first-skin-layer polymer melt, and the second-skin-layer polymer melt to form the monolithic core layer, the first skin layer, and a second skin layer to form a multilayer film. The process may further comprise a step of laminating the second skin layer of the multilayer film to a second fibrous layer by adhesively bonding the second fibrous layer to the second skin layer with a continuous layer or coating of adhesive or with a discontinuous layer or coating of adhesive.

### EXAMPLES

The present disclosure is further illustrated by the following examples, which in no way should be construed as being limiting. That is, the specific features described in the following examples are merely illustrative and not limiting.

Test Methods

The basis weight of the following comparative examples and examples was measured in a way that is consistent with ASTM D3776 test method. The results were provided in units of mass per unit area in g/m² (gsm) and were obtained by weighing a minimum of ten pieces for each sample of the comparative examples and examples, in which each piece had the dimensions of 10 cm by 10 cm.

The strip tensile strength of the web is measured according to ASTM test method D5035.

Thickness was measured as per ASTM test method D5729.

Hydrohead of the film was measured as per the INDA standard IST 80.6. During the tests, a PET spunbond (34 gsm, Reemay®, Style No. 2014) was used as a backing material. The test is stopped once it reaches 200 mbar even if there is no sign of water penetration. If the test, for instance, reaches 200 mbar then the test is stopped and the results are reported as >200 mbar.

Pinhole test for film laminate are normally performed by applying sufficient amounts of methylene blue isopropynol solution (1 gram of methylene blue powder dissolved in one liter of 50% isopropynol) onto a 2 square meter surface of the laminate. After 5 minutes, the other side of the laminate is inspected for signs of the colored solution having penetrated the film (e.g., color strikethrough). A product with less than 1 pinhole per 10 square meters is often accepted as a pinhole-free product.

MVTR was measured with the upright cup method per ASTM E96D using water, a temperature of 32° C. and an ambient humidity of 50%.

Resistance to viral penetration was tested following ASTM F1671 using the viral barrier test at Nelson's Laboratories of UT.

Contact angle was measured according to ASTM D5946. In this regard, an existing film was thermally sealed over a polypropylene sheet frame having dimensions of 4.5″×3″ with an opening of 2.5″×2.0″. The framed sample was soaked in at least 100 ml of analytical grade acetone in a sealed glass container for 24 hours and then air dried at 72±2° F. and 45±2% relative humidity (RH) for approximately 4 hours before testing. The measurements were performed on each side (i.e., designated as side ‘A’ and side ‘B’) of the film at conditions of 72±2° F. and 45±2% RH. A camera was used to image each 5 μL deionized water droplet deposited onto the film, and Image Pro software was used to make the angle measurements. A series of ten (10) measurement readings were obtained from each side of the film specimen with the overall average value of the contact angle being reported. From a polarity viewpoint for a given film, contact angle is an indirect measurement of a material surface energy. In this regard, the higher the surface energy of the solid material (e.g., film surface), the lower the contact angle of a water droplet.

Process for the Formation of the Multilayer Film and Laminates Thereof

All the samples (e.g., for the comparative examples and examples) were made on a film casting system that include two extruders capable of feeding different formulations to a multilayer extrusion die. The die block was configured to produce an ABA film configuration where the two outer skins (i.e., ‘A’ layers) were made from one formulation and the core (i.e., ‘B’ layer) of the film was made from a different formulation. The film was cast on a chill roll with a fine pattern finish and subsequently winded into a roll.

### Comparative Example 1

The raw materials used in this comparative example include a polyether-block-ester from DSM under the brand name of Arnitel®, a color master batch, and a releasing agent. The Arnitel® resin (i.e., Arnitel® VT3108) has a melting temperature of 185° C., volume melt flow rate of 10 cm³/10 min when tested per ISO 1133 and a water absorption rate of 35% per ISO 62. It was dried at 85° C. for at least 4 hours in a dehumidifying drier and then co-extruded to a 3.5 meter wide cast film die, where the die is equipped with a combining block and the temperature was set at 220° C.±2° C. The ‘A’ layers are a blend of the Arnitel® resin, a polyolefin resin, color master batch, and processing agent. The ‘B’ layer is 100% of the foregoing Arnitel®. By controlling the melt temperature, melt pressure, extrusion rate, chill roll speed and other parameters, a 12 gsm film with above structure (i.e., ABA) was produced. The key properties are presented in the Table 1 and identified as “sample A”.

### Comparative Example 2

The raw materials used in this comparative example includes a compound of a polyether-block-ester, from DSM under the brand name of Arnitel®, a polyolefin resin, and EMA (ethyl methyl acrylate). The Arnitel® resin (i.e., Arnitel® VT3108) has a melting temperature of 185° C., volume melt flow rate of 10 cm³/10 min when tested per ISO 1133 and a water absorption rate of 35% per ISO 62. The EMA is a random copolymer of ethylene and methyl acrylate, with a melt index of 2-3.5 g/10 min when tested per ISO 1133, a density of 0.95 g/cm³ and a melting temperature of 61° C. This compound was dried at 85° C. for at least 4 hours in a dehumidifying drier and then co-extruded to a 3.5 meter wide cast film die, where the die is equipped with a combining block and temperature was set at 220° C.±2° C. The ‘A’ layers are a blend of Arnitel® resin, an impact polypropylene, and EMA at a ratio of 50:45:15. The ‘B’ layer was 100% of the foregoing Arnitel®. By controlling the melt temperature, melt pressure, extrusion rate, chill roll speed and other parameters, a 12 gsm film with above structure (i.e., ABA) was produced. The key properties are presented in the Table 1 and identified as “sample 1A”.

### Example 3

The raw materials used in this example are two polyether-block-esters, namely Arnitel® A and Arnitel® B, both from DSM under the brand name of Arnitel®. The Arnitel® A resin has a melting temperature of 189° C., volume melt flow rate of 46 cm³/10 min when tested per ISO 1133 and a water absorption rate of 0.7% per ISO 62. The Arnitel® B resin has a melting temperature of 185° C., volume melt flow rate of 10 cm³/10 min when tested per ISO 1133 and a water absorption rate of 35% per ISO 62. They were dried at 85° C. for at least 4 hours in a dehumidifying drier and then co-extruded to a 3.5 meter wide cast film die, where the die was equipped with a combining block and the temperature was set at 220° C.±2° C. The ‘A’ layers are a blend of Arnitel® A and an anti-block process agent. The ‘B’ layer was 100% Arnitel® B. By controlling the melt temperature, melt pressure, extrusion rate, chill roll speed and other parameters, a 12 gsm film (Sample B) with above structure (i.e., ABA) is produced. The same structure films were produced at basis weight of 11 gsm (Sample C) and 10 gsm (Sample D). The key properties are presented in the Table 1.

TABLE 1
Film Examples and Their Key Properties

| | | Basis | | Average | Hydro | |
|---|---|---|---|---|---|---|
| Sample | Lot | weight, | Thickness, | Density, | head*, | MVTR |
| ID | Numbers | gsm | Micron | g/cc | mbar | g/sm/day |
| A | 7099M | 12 | 26 | 0.46 | >200 | 1460 |
| A1 | 7099M1 | 12 | 26 | 0.47 | >200 | 960 |
| B | 8000M | 12 | 28 | 0.42 | >200 | 1350 |
| C | 8000M | 11 | 22 | 0.5 | >200 | 1390 |
| D | 8000M | 10 | 20 | 0.5 | >200 | 1410 |

*The hydro head values are tested with a supportive screen at a pressure increase rate of 60 mbar/min. If the pressure reached 200 mbar without failure, the test was stopped and the results were reported as “>200 mbar”.

### Example 4

Each of the above films were laminated with two layers of nonwovens, where the film is sandwiched between the nonwoven layers with a hot melt adhesive. The first nonwoven was a typical polypropylene spunbond, which can be made from a formulation that comprises mainly isotactic polypropylene having a viscosity of 35±5 MFR. The second nonwoven was a typical polypropylene spunbond, which can be made from a formulation that comprises mainly isotactic polypropylene having a viscosity of 35±5 MFR for spunbond grade resins and a viscosity ranged from 300-2000 MFR for melt blown grade resins as measured by ISO 1133 (230° C. and 2.16 Kg). Such nonwovens can be made on Reicofil spunmelt production equipment sold by Reifenhauser Reicofil, Troisdorf, Germany. The structures of these laminates and their typical properties are presented in Table 2.

TABLE 2
Laminate Examples and Their Key Properties

| | | | | | | | Viral |
|---|---|---|---|---|---|---|---|
| | | Basis | CD | Trap | Hydro | | Barrier |
| Sample | Film | weight | Grab | Tear | head, | MVTR | By |
| ID | used | gsm | lbf | lbf | mbar | g/sm/day | F1671 |
| E | A | 60.1 | 26.37 | 7.51 | 197.3 | 1283 | 32 |
| | | | | | | | tested |
| | | | | | | | 32 |
| | | | | | | | passed |
| E1 | A1 | 60.3 | 26.12 | 7.45 | 199.8 | 940 | — |
| F | B | 61.1 | 26.41 | 6.51 | 206.8 | 1226 | 32 |
| | | | | | | | tested |
| | | | | | | | 32 |
| | | | | | | | passed |
| G | C | 59.93 | 26.19 | 6.42 | 204.4 | 1242 | — |
| H | D | 59.21 | 26.00 | 6.56 | 202.2 | 1389 | — |

### Example 5

Heat seals forming seams of samples E and F were conducted using a pilot heat seal machine, model PW3024 from Packworld USA. In general, these materials can be properly sealed at a sealing temperature ranged from 190-220° C., a sealing pressure 3-4 PSI per inch of seal bar, and a sealing time of 3-6 second when using the heat seal machine. The seams are identified as ‘EE’ and ‘FF’, respectively, and evaluated by seam tensile strength, hydro head pressure, and F1671 test. The seam tensile strength was tested following ASTM D5035-95 with the seam being oriented perpendicular to the pulling force direction. The hydro head pressure test was a modified hydro head test according to AATCC 127 to simulate the pressuring step of F1671. During the hydro head pressure test, a supportive screen (34 gsm PET spunbond, Reemay®, Style No. 2014) was used above the heat seal seam specimen. The pressure was increased to 140 mbar, and this pressure was held steady for 60 seconds. A seam is considered as passing this test if there is no failure along the seam observed after the 60 second time requirement. The data are presented in Table 3.

TABLE 3
Heat Seal Seam Properties

| | Heat seal | | Hydro Head | |
|---|---|---|---|---|
| | conditions | | Pressure | |
| Sample | (Sealer model | Strip Tensile | 140 mbar × | Viral Barrier |
| ID | PW3024) | N/50 mm | 60 sec | By F1671 |
| EE | Temp. = 220° C. | 36.97 | Pass | 3 tested, |
| | Press. = 70 psi | | | 2 passed |
| FF | Time = 5 sec | 36.53 | pass | 32 tested, |
| | | | | 32 passed |

Measurement of Contact Angles

As noted above, various films were tested for their contact angle in accordance with ASTM 5946. In this regard, the following five (5) different films were tested: (i) Ahlstrom BVB film (S1); (ii) an inventive film as described herein including skins formed from Arnitel® A (described above) and including a micro-square pattern (S2); (iii) an inventive film as described herein including skins formed from Arnitel® A (described above) and including an irregular matte finish (S3); (iv) a comparative film including Arnitel® B (described above) surfaces and including a micro-square pattern (S4); and (v) an additional comparative film including Arnitel® B (described above) surfaces and including a micro-square pattern (S5). The results are presented in Table 4.

TABLE 4
Contact Angle Results

| | Contact Angle of | Contact Angle of |
|---|---|---|
| Sample | Side ‘A’ (degrees) | Side ‘B’ (degrees) |
| S1 | 75.1 | 68.8 |
| S2 | 67.9 | 66.8 |
| S3 | 64.9 | 65.7 |
| S4 | 55.5 | 38.7 |
| S5 | 55.0 | 58.7 |

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A breathable multilayer film comprising:
a monolithic core layer comprising a core-layer composition; wherein the core-layer composition comprises a core-layer highly breathable polymer and has a core-layer water absorption rate; and
at least a first skin layer comprising a first-skin-layer composition; wherein the first-skin-layer composition comprises a first-skin-layer highly breathable polymer and has a first-skin-layer water absorption rate;
wherein the core-layer water absorption rate is at least about 10 times larger than first-skin-layer water absorption rate.

2. The film of claim 1, wherein the core-layer water absorption rate is from at least about 10 to about 50 times larger than first-skin-layer water absorption rate.

3. The film of claim 1, wherein the breathable multilayer film comprises at least one of (i) an average density being less than about 1.0 g/cc and (ii) a contact angle from about 60 to about 70 degrees as determined according to ASTM D5946.

4. The film of claim 1, wherein the core-layer water absorption rate comprises at least about 15% as determined according to ISO 62.

5. The film of claim 1, wherein the first-skin-layer water absorption rate comprises less than about 5% as determined according to ISO 62.

6. The film of claim 1, further comprising a second skin layer; wherein the monolithic core layer is directly or indirectly sandwiched between the first skin layer and the second skin layer, and wherein the second skin layer comprises a second-skin-layer composition, the second-skin-layer composition comprises a second-skin-layer highly breathable polymer and has a second-skin-layer water absorption rate, in which the core-layer water absorption rate is at least about 10 times larger than second-skin-layer water absorption rate.

7. The film of claim 6, wherein the first-skin layer, the second-skin layer, or both are monolithic.

8. The film of claim 6, wherein at least one of the first-skin-layer composition, the second-skin-layer composition, or the core-layer composition is devoid of a soft polymer having a T_{g} below 0° C.

9. The film of claim 6, wherein at least one of the first-skin-layer composition, the second-skin-layer composition, or the core-layer composition is devoid of a pore-forming filler.

10. The film of claim 1, wherein the multilayer film comprises an MVTR of at least 700 g/m²/day as determined by ASTM Test Method E-96D.

11. The film of claim 1, wherein the multilayer film has a basis weight comprising from about 5 to about 30 gsm and a thickness from about 10 microns to about 50. microns.

12. The film of claim 6, wherein the core layer has a core-layer thickness, the first skin layer has a first-skin-layer thickness, the second skin layer has a second-skin-layer thickness, and the core-layer thickness is greater than each of the first-skin-layer thickness and the second-skin-layer thickness.

13. The film of claim 12, wherein the core-layer thickness is greater than an aggregate of the first-skin-layer thickness and the second-skin-layer thickness.

14. The film of claim 12, wherein the multilayer film comprises no more than 50% by weight of the first skin layer, the second skin layer, or an aggregate of the first skin layer and the second skin layer.

15. The film of claim 1, wherein the core-layer highly breathable polymer comprises at least one of a thermoplastic polyurethane, a polyether-block-amide copolymer, a polyether-block-ester copolymer, polyester-block-amide copolymer, or a copolyester thermoplastic elastomer.

16. The film of claim 1, wherein the first skin layer is less hygroscopic and less tacky than the core layer.

17. A laminate, comprising:
(a) a breathable multilayer film comprising
(i) a monolithic core layer comprising a core-layer composition; wherein the core-layer composition comprises a core-layer highly breathable polymer and has a core-layer water absorption rate; and
(ii) at least a first skin layer comprising a first-skin-layer composition;
wherein the first-skin-layer composition comprises a first-skin-layer highly breathable polymer and has a first-skin-layer water absorption rate;
wherein the core-layer water absorption rate is at least about 10 times larger than first-skin-layer water absorption rate; and
(b) at least a first fibrous layer.

18. The laminate of claim 18, wherein the breathable multilayer film and the first fibrous layer are laminated via a first adhesive layer positioned between the breathable multilayer film and the first fibrous layer.

19. A process for forming a breathable multilayer film, comprising co-extruding a multilayer film, wherein the multilayer film comprises (i) a monolithic core layer comprising a core-layer composition; wherein the core-layer composition comprises a core-layer highly breathable polymer and has a core-layer water absorption rate; and (ii) at least a first skin layer comprising a first-skin-layer composition; wherein the first-skin-layer composition comprises a first-skin-layer highly breathable polymer and has a first-skin-layer water absorption rate; wherein the core-layer water absorption rate is at least about 10 times larger than first-skin-layer water absorption rate.

20. A process for forming a laminate, comprising:
(a) providing a multilayer film comprising (i) a monolithic core layer comprising a core-layer composition; wherein the core-layer composition comprises a core-layer highly breathable polymer and has a core-layer water absorption rate; and (ii) at least a first skin layer comprising a first-skin-layer composition; wherein the first-skin-layer composition comprises a first-skin-layer highly breathable polymer and has a first-skin-layer water absorption rate; wherein the core-layer water absorption rate is at least about 10 times larger than first-skin-layer water absorption rate; and
(b) laminating the first skin layer of the multilayer film to a first fibrous layer.
